(19) United States
(12) Patent Application Publication
(10) Pub. No.: US 2026/0030003 A1
(43) Pub. Date: Jan. 29, 2026

(54) METHOD, DEVICE, AND PRODUCT FOR PROCESSING SOFTWARE MODULES

(71) Applicant: DELL PRODUCTS L.P., ROUND ROCK, TX (US)

(72) Inventors: Meng ZHOU, Shanghai (CN); Xinyu LUO, Shanghai (CN); Haiyan ZHANG, Shanghai (CN); Min LIU, Shanghai (CN); Yongsheng GUO, Shanghai (CN); Yubing ZHANG, Shanghai (CN)

(21) Appl. No.: 18/930,180

(22) Filed: Oct. 29, 2024

(30) Foreign Application Priority Data
Jul. 26, 2024 (CN) 202411017681.2

(51) Int. Cl. G06F 8/41

(52) U.S. Cl. CPC G06F 8/41

(57) ABSTRACT

A method includes acquiring and determining a first set of third-party libraries referenced by a first module in a target application and a second set of third-party libraries referenced by a second module in the target application. The method further includes determining a degree of correlation between the first set of third-party libraries and the second set of third-party libraries. The method further includes adjusting at least one of the first module and the second module in response to the degree of correlation being greater than a predetermined threshold. By automatically comparing the correlation between the sets of third-party libraries referenced by the modules, this method can adjust similar modules, such as replacing or merging similar modules, thereby reducing the number of third-party libraries in the target application, reducing redundant modules, and reducing the volume of the target application.

### TECHNICAL FIELD

The present disclosure relates to the field of computer programming, and more particularly, to a method, device, and computer program product for processing software modules.

### BACKGROUND

During programming of a large-scale software application, the complexity and technical challenges of application management often require detailed and effective decomposition of a massive development task into a plurality of modules to ensure the smooth progress of the application and high-quality delivery of a final product. Decomposition of the application into a plurality of modules is a core strategy in this process, which not only helps reduce the difficulty of overall application development, but also promotes collaboration and specialized division of labor among teams.

In general, each module should independently complete one function or a set of closely related functions as much as possible, thereby reducing dependencies between modules, improving the maintainability and scalability of the system, and pursuing high cohesion and low coupling. Correspondingly, according to application requirements and module characteristics, the development team is divided into multiple groups, and each group is responsible for designing, coding, testing, and documentation of a module. Through modular design and multi-team collaboration, development difficulty can be effectively reduced, and development efficiency can be improved, while ensuring the quality and maintainability of the software product.

### SUMMARY OF THE INVENTION

Embodiments of the present disclosure propose a method, device, and computer program product for processing modules.

In a first aspect of the embodiments of the present disclosure, a method for processing modules is provided. The method includes acquiring and determining a first set of third-party libraries referenced by a first module in a target application and a second set of third-party libraries referenced by a second module in the target application. The method further includes determining a degree of correlation between the first set of third-party libraries and the second set of third-party libraries. The method further includes adjusting at least one of the first module and the second module in response to the degree of correlation being greater than a predetermined threshold.

In a second aspect of the embodiments of the present disclosure, an electronic device is provided. The electronic device includes one or a plurality of processors; and a storage apparatus for storing one or a plurality of programs, wherein the one or a plurality of programs, when executed by the one or a plurality of processors, cause the one or a plurality of processors to perform actions including acquiring and determining a first set of third-party libraries referenced by a first module in a target application and a second set of third-party libraries referenced by a second module in the target application. These actions further include determining a degree of correlation between the first set of third-party libraries and the second set of third-party libraries. These actions further include adjusting at least one of the first module and the second module in response to the degree of correlation being greater than a predetermined threshold.

In a third aspect of the embodiments of the present disclosure, a computer program product is provided, the computer program product being tangibly stored on a non-volatile computer-readable medium and including machine-executable instructions, wherein the machine-executable instructions, when executed, cause a machine to perform actions including acquiring and determining a first set of third-party libraries referenced by a first module in a target application and a second set of third-party libraries referenced by a second module in the target application. These actions further include determining a degree of correlation between the first set of third-party libraries and the second set of third-party libraries. These actions further include adjusting at least one of the first module and the second module in response to the degree of correlation being greater than a predetermined threshold.

It should be understood that the content described in the Summary of the Invention part is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above and other features, advantages, and aspects of the embodiments of the present disclosure will become more apparent with reference to the accompanying drawings and the following detailed description. In the accompanying drawings, identical or similar reference numerals represent identical or similar elements, in which

FIG. 1 is a schematic diagram of an example environment in which embodiments of the present disclosure can be implemented;

FIG. 2 is a flow chart of a method for processing modules according to some embodiments of the present disclosure;

FIG. 3 is a schematic diagram of a method for processing modules according to an embodiment of the present disclosure;

FIG. 4A is a schematic diagram of analyzing dependencies between modules according to an embodiment of the present disclosure;

FIG. 4B is a schematic diagram of determining an identifier matrix according to an embodiment of the present disclosure;

FIG. 4C is a contrastive diagram of the degree of correlation according to an embodiment of the present disclosure;

FIG. 5 is a schematic diagram of module pairing according to an embodiment of the present disclosure;

FIG. 6 is a schematic diagram of module adjustment according to an embodiment of the present disclosure;

FIG. 7A is a schematic diagram of module evaluation according to an embodiment of the present disclosure;

FIG. 7B is a schematic diagram of calculating an initial score according to an embodiment of the present disclosure;

FIG. 7C is a schematic diagram of calculating an intermediate score vector according to an embodiment of the present disclosure;

FIG. 7D is a schematic diagram of calculating a score according to an embodiment of the present disclosure;

FIG. 8 is a schematic diagram of a method for processing modules according to an embodiment of the present disclosure; and

FIG. 9 illustrates a schematic block diagram of an example device that can be used to implement embodiments of the present disclosure.

### DETAILED DESCRIPTION

The embodiments of the present disclosure will be described below in further detail with reference to the accompanying drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of the embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

In related technologies, programming of a large-scale software application is divided into a plurality of modules and completed by a plurality of development groups of a development team. For example, one development group is responsible for one module, and each development group uses third-party libraries to code the assigned module to varying degrees. The division of the application programming and the development team leads to emergence of information barriers between development groups, which may result in a significant amount of redundancy between different modules.

Therefore, the present disclosure proposes a method for processing modules. The present disclosure relates to a method, device, and computer program product for processing modules. The method includes acquiring and determining a first set of third-party libraries referenced by a first module in a target application and a second set of third-party libraries referenced by a second module in the target application. The method further includes determining a degree of correlation between the first set of third-party libraries and the second set of third-party libraries. The method further includes adjusting at least one of the first module and the second module in response to the degree of correlation being greater than a predetermined threshold. According to the method of the present disclosure, by automatically comparing the correlation between the sets of third-party libraries referenced by the modules, similar modules can be adjusted, such as replacing or merging similar modules, thereby reducing the number of third-party libraries in the target application, reducing redundant modules, and reducing the volume of the target application. This is beneficial for the user of the target application. For example, it can improve the competitiveness of the target application and to some extent reduce hardware requirements for the user's device, such as disk size requirements and running memory requirements. This is also beneficial for developers. For example, it can be easier to maintain the use of third-party libraries, achieve unified management and upgrading of the third-party libraries, and reduce potential security risks that the third-party libraries may bring.

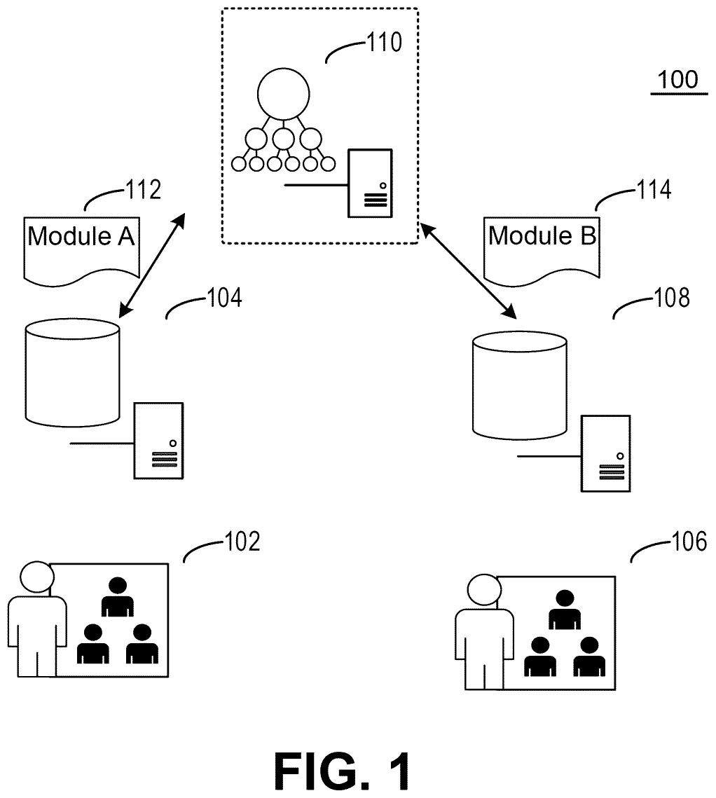

FIG. 1 is a schematic diagram of an example environment 100 in which embodiments of the present disclosure can be implemented. As shown in FIG. 1, the environment 100 may include a development group 102, a server cluster 104, a development group 106, a server cluster 108, and a module processing unit 110. Communications between the server clusters 104 and 108 and with the module processing unit 110 may be achieved via a network (not shown). The network may be, for example, a wide area network (WAN), a local area network (LAN), a wireless network, a public telephone network, an intranet, and any other type of network well known to those skilled in the art. The communication may also be achieved through physical lines (such as fiber optics and cables). The module processing unit 110, the server cluster 104, and the server cluster 108 may form a part of a distributed system. It is understandable that the distributed system is a system consisting of a plurality of nodes, and these nodes may be computers, servers, or other processing nodes that are connected to each other over a network and work collaboratively. In the distributed system, a user usually faces a unified service portal, behind which a plurality of nodes work together to provide this service. These nodes may be located at different physical locations, and they communicate and coordinate through message passing. The distributed system may process and store data and share the data among different nodes to achieve higher availability, reliability, and performance. In addition, the distributed system may be used for performing a variety of tasks (including a target task) including, but not limited to, data processing, storage management, and scientific computing. The network may be, for example, a wide area network (WAN), a local area network (LAN), a wireless network, a public telephone network, an intranet, and any other type of network well known to those skilled in the art.

In this embodiment, a target application is decomposed into a plurality of modules, including a module A 112 and a module B 114, wherein the module A 112 is assigned to the development group 102 for completion and the module B 114 is assigned to the development group 106 for completion. During this process, the development group 102 utilizes the server cluster 104 for programming. The development group 106 utilizes the server cluster 108 for programming. The module A 112 and the module B 114 obtained through programming may be transferred to the module processing unit 110, and the module processing unit 110 performs the method for processing modules to determine whether the module A 112 and the module B 114 are redundant.

The module processing unit 110 determines a set of third-party libraries referenced by the module A 112 in the target application and a set of third-party libraries referenced by the module B 114 in the target application. In software programming, a third-party library refers to a codebase created and maintained by an entity other than the development group (usually other developers or organizations). These libraries typically contain a pre-written set of functions, classes, and other functions that may be integrated into a local application to implement specific functions without writing these functions from scratch. In a process of identifying third-party libraries, as third-party libraries usually follow certain naming conventions, the sets of third-party libraries referenced by the module A 112 and the module B 114 may be determined by searching for specific keywords. In addition, the sets of third-party libraries referenced by the module A 112 and the module B 114 may be determined by retrieving specific code segments (code segments required for referencing third-party libraries).

The module processing unit 110 determines a degree of correlation between the two sets of third-party libraries. The module processing unit 110 may perform statistical analysis and calculations on the modules A 112 and B 114 to determine the degree of correlation between the two sets of third-party libraries. For example, the number and proportion of identical third-party libraries between the sets of third-party libraries referenced by the module A 112 and module B 114 may be counted to calculate the degree of correlation between the two.

The module processing unit 110 adjusts at least one of the module A 112 and the module B 114 in response to the degree of correlation being greater than a predetermined threshold. In the case of being greater than the predetermined threshold, the module processing unit 110 may provide an adjustment plan, and after the user agrees to the adjustment, adjust at least one of the module A 112 and the module B 114 according to the provided adjustment plan. For example, the module processing unit 110 may transfer a backup of the module A 112 from the server cluster 104 to the server cluster 108 to replace the module B 114 in the server cluster 108. The module processing unit 110 may make adaptive adjustments in the replacement process, such as adjusting the number of parameters and names of parameters of the backed-up module A 112 to be consistent with the number of parameters and names of parameters of the module B 114.

An instance of the module processing unit 110 may be a server for processing modules. For example, the module processing unit 110 is a cloud server used for providing basic cloud computing services such as cloud services, cloud databases, cloud computing, cloud functions, cloud storage, network services, cloud communications, middleware services, domain name services, security services, Content Delivery Networks (CDNs), and big data and artificial intelligence platforms.

It should be noted that the method of the present disclosure may also be applied to scenarios of non-distributed systems, such as scenarios of centralized systems. In this embodiment, although the module processing unit 110 is shown as a separate device, the module processing unit 110 may be embedded into the server cluster 104, embedded into the server cluster 108, and so on.

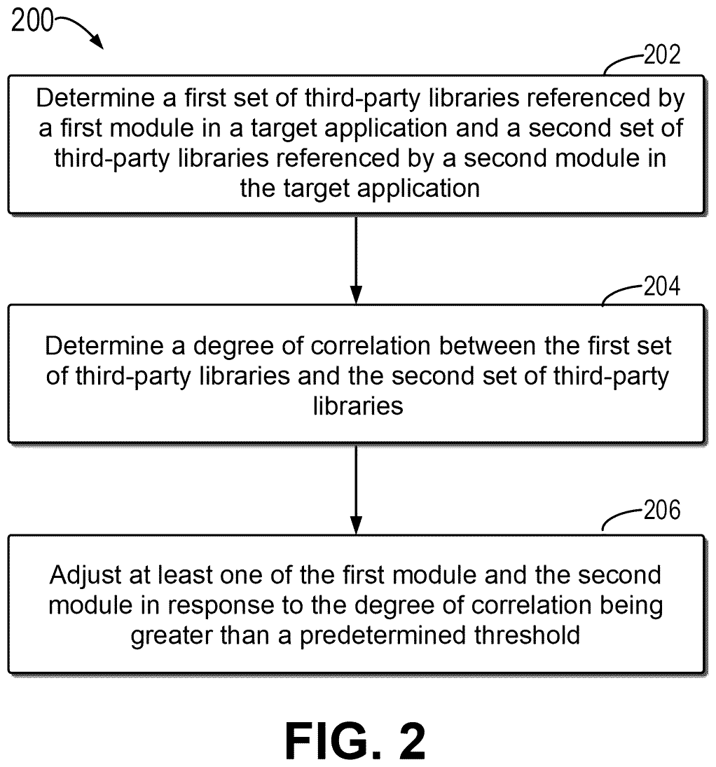

FIG. 2 is a flow chart of a method for processing modules according to some embodiments of the present disclosure. As shown in FIG. 2, the flow chart 200 includes a block 202 to a block 206. At the block 202, a set of third-party libraries referenced by a first module in a target application and a set of third-party libraries referenced by a second module in the target application are determined. The module may be, for example, software code that implements a certain function or effect in the target application. For the sake of development efficiency and quality, one or more third-party libraries may be referenced in the module. Examples of third-party libraries include org.elasticsearch, org.apache.lucene, and the like. A module may usually be further decomposed into a plurality of submodules, and each of the submodules may, for example, implement a more specific function. The various third-party libraries referenced in the submodules included in the module may serve as a set of third-party libraries of the module.

At the block 204, a degree of correlation between the two sets of third-party libraries is determined. As mentioned above, due to the existence of information barriers between development groups, there may be similar modules. The degree of correlation is used for quantifying the similarity between modules from the perspective of third-party libraries referenced by the modules. For example, if there is a high degree of overlap between the sets of third-party libraries referenced by two modules, it indicates that the two modules have referenced many identical third-party libraries. This denotes that there may be a large number of logical implementations with duplicated functions between the two modules, and therefore, they may be identified as two modules suspected of function duplication.

At the block 206, at least one of the first module and the second module is adjusted in response to the degree of correlation being greater than a predetermined threshold. The predetermined threshold is a preset empirical value. For example, the degree of correlation between two modules should be high, and it can be concluded that the two modules are similar. At this point, one module may be replaced with another to reduce the volume by the size of one module and improve the running efficiency of the target application. The two modules may also be merged to form one module, thereby reducing a certain amount of application volume, and so on.

According to the method of the present disclosure, by automatically comparing the correlation between the sets of third-party libraries referenced by the modules, similar modules can be adjusted, such as replacing or merging similar modules, thereby reducing the number of third-party libraries in the target application, reducing redundant modules, and reducing the volume of the target application. This is beneficial for the user of the target application. For example, it can improve the competitiveness of the target application and to some extent reduce hardware requirements for the user's device, such as disk size requirements and running memory requirements. This is also beneficial for developers. For example, it can be easier to maintain the use of third-party libraries, achieve unified management and upgrading of the third-party libraries, and reduce potential security risks that the third-party libraries may bring.

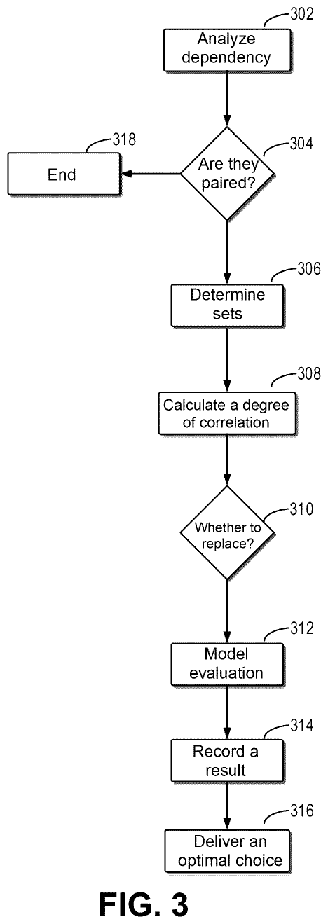

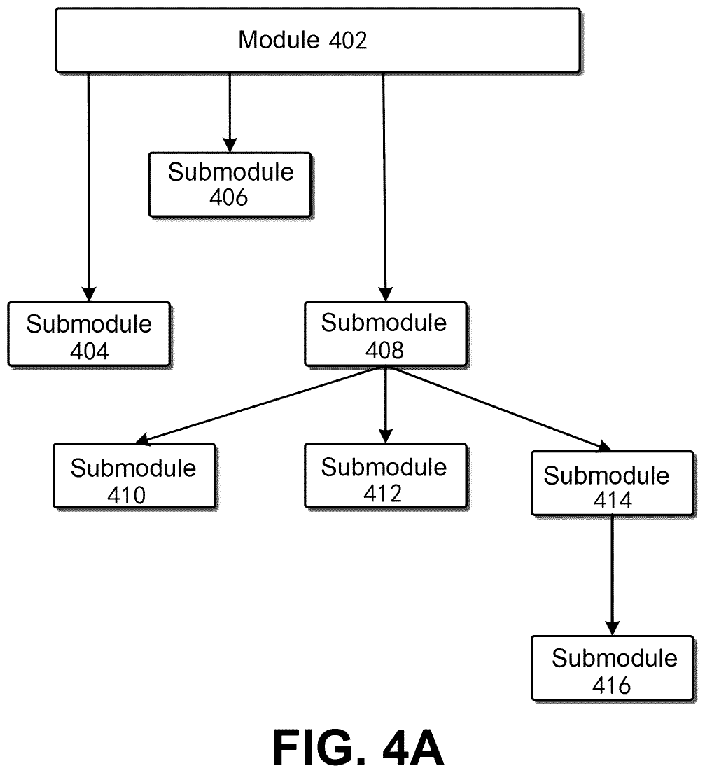

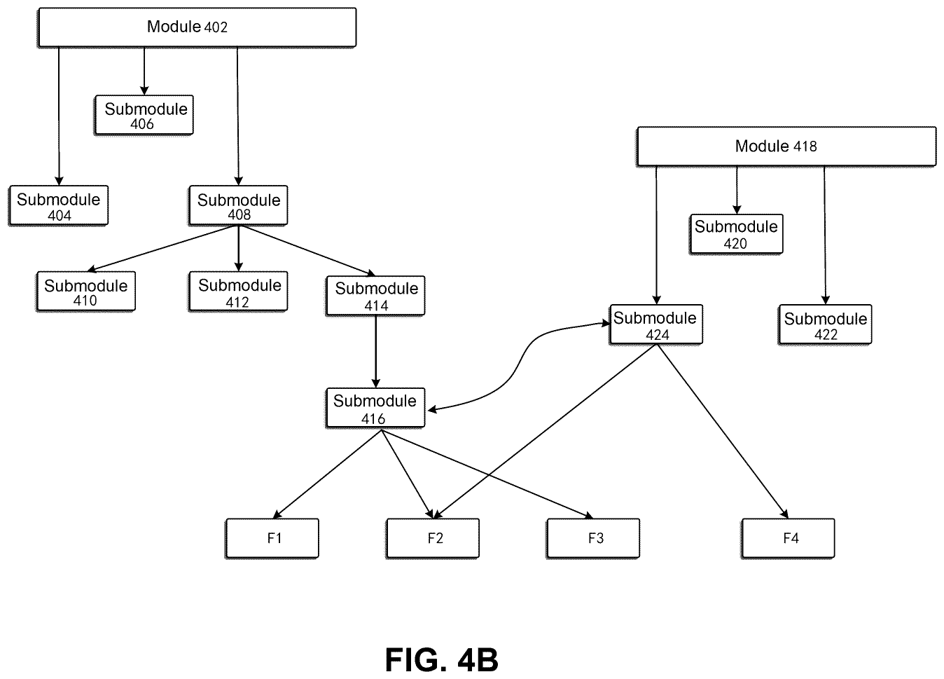

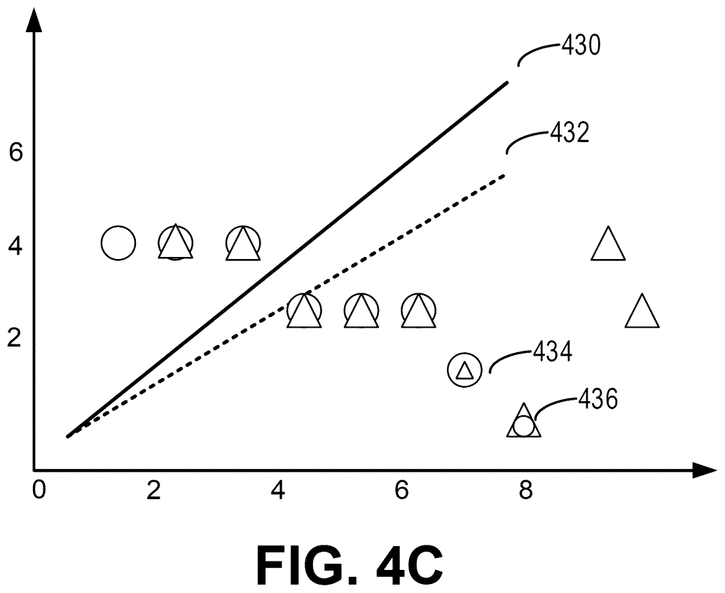

FIG. 3 is a schematic diagram of a method for processing modules according to an embodiment of the present disclosure. At 302, it starts analyzing dependencies between modules. The dependencies refer to dependencies between modules (or submodules) and modules (or submodules) and reference relationships between modules (or submodules) and third-party libraries. For example, a submodule A-1 in the module A is dependent on a submodule A-1-1, the submodule A-1 refers to the third-party library org.elasticsearch, and the submodule A-1-1 refers to the third-party library org.apache.lucene, all of which belong to the dependencies. When analyzing the dependencies between modules, it is necessary to start from a submodule of one module, and the submodule is not depended on by any other submodule, and the third-party libraries referenced by each depending submodule are analyzed one by one, thereby obtaining a set of third-party libraries referenced by the module A. FIG. 4A is a schematic diagram of analyzing dependencies between modules according to an embodiment of the present disclosure. As shown in FIG. 4A, a module 402 includes three submodules, namely, a submodule 404, a submodule 406, and a submodule 408. These three submodules are not depended on by other submodules, and therefore, the three submodules are independent of each other. The submodule 408 is dependent on three submodules, namely, a submodule 410, a submodule 412, and a submodule 414. The submodule 414 is directly dependent on a submodule 416, and the submodule 408 is indirectly dependent on the submodule 416. The submodule 408 is associated with the submodules 410, 412, 414, and 416 (that is, there are direct or indirect dependencies).

When analyzing the dependency of the module 402, the analysis may start from any one of the submodule 404, the submodule 406, and the submodule 408. If starting from the submodule 408, a third-party library referenced by the submodule 408 is added to the set of third-party libraries. Then, the submodules that the submodule 408 is dependent on, namely, the submodule 410, the submodule 412, and the submodule 414, are determined. Third-party libraries referenced by the submodule 410, the submodule 412, and the submodule 414 are determined respectively, and these third-party libraries are added to the set of third-party libraries. The submodule 408 is indirectly dependent on the submodule 416, and therefore, the submodule 416 is associated with the submodule 408, and the third-party library referenced by the submodule 416 is added to the set of third-party libraries. In the example of FIG. 4A, the submodule 416 has no lower-level submodules, and therefore, the analysis of dependencies between modules ends. The obtained set of third-party libraries may be used to represent the set of third-party libraries of the module 402 for analyzing the degrees of correlation between the module 402 and other modules, so as to obtain the basis for whether to process the module 402 or the other modules. A similar method is used to determine sets of third-party libraries of the other modules. The other modules refer to modules with different programming identifiers. The programming identifier indicates an identifier of a programming entity (that is, a development group) of the corresponding module. Different programming identifiers mean different development groups.

Returning to the embodiment in FIG. 3, for example, it starts from the submodule A-1 in the module A and the submodule B-1 in the module B. The process proceeds to 304 to check if the submodule A-1 and the submodule B-1 are paired. Pairing refers to whether two submodules belong to the same module. If a submodule A-2 used for pairing is also part of the module A, it means that the module A and the module B are programmed by the same development group. Therefore, the submodule A-1 and the submodule A-2 cannot be paired, and the process proceeds to 318 to end the analysis of dependencies between modules. In this embodiment, the submodule B-1 used for pairing is part of the module B, which means that the module A and the module B are programmed by different development groups, so the submodule A-1 and the submodule B-1 can be paired. After the pairing, a set of third-party libraries referenced by the module A is determined according to the submodule A-1, and a set of third-party libraries referenced by the module B is determined according to the submodule B-1.

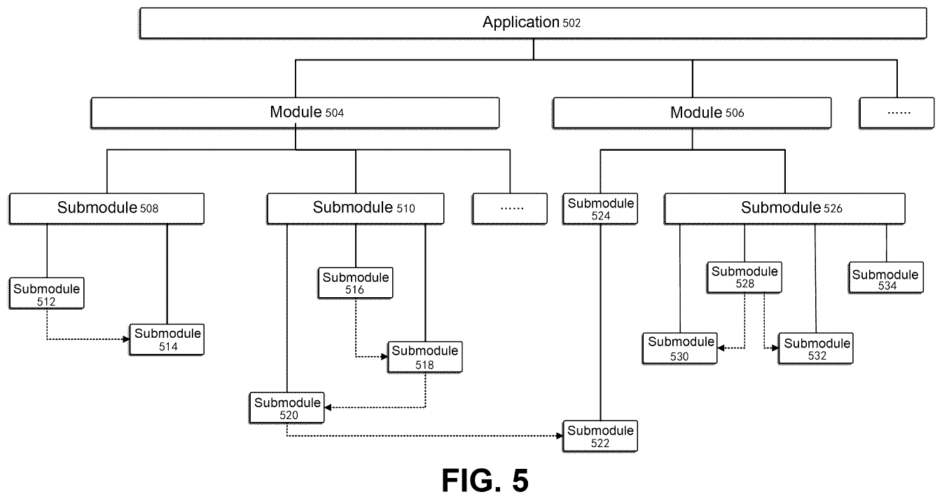

FIG. 5 is a schematic diagram of module pairing according to an embodiment of the present disclosure. The embodiment of FIG. 5 analyzes different pairing states for an application 502. In this embodiment, the application 502 includes a module 504 and a module 506, as well as other modules, and each of the modules has a different programming identifier. In combination with the description of the embodiment in FIG. 4A, in the module 504, the submodules that are not depended on by other submodules include a submodule 508 and a submodule 510. The submodule 508 is dependent on a submodule 512 and a submodule 514. The submodule 512 is dependent on the submodule 514. The submodule 510 is dependent on submodules 516, 518, and 520, the submodule 516 is dependent on the submodule 518, and the submodule 518 is dependent on the submodule 520. The submodule 520 is dependent on a submodule 522.

In the module 506, the submodules that are not depended on by other submodules are a submodule 524 and a submodule 526. As an example, the submodule 524 includes a submodule 522, but the submodule 522 is not regarded as belonging to the module 506. This is because the submodule 522 belongs to the module to which the depended submodule belongs, the depended party of the submodule is the submodule 520, and the submodule 520 belongs to module 504. Therefore, the submodule 522 is regarded as belonging to the module 504. This is because the submodules with dependencies are often programmed by the same development group, which can further reduce redundancy and reduce the amount of calculation.

Similarly, the submodule 526 includes submodules 528, 530, 532, 534, wherein the submodule 528 is dependent on the submodules 530 and 532, respectively. At this point, four sets of dependency sequences may be obtained. The first set of dependency sequence is 508→512→514, the second set of dependency sequence is 510→516→518→520→522, the third set of dependency sequence is 528→(530, 532), wherein the submodules 530 and 532 are at the same level, and the fourth set of dependency sequence is 534. Correspondingly, third-party libraries referenced by the various submodules in the first set of dependency sequence constitute a first set, third-party libraries referenced by the various submodules in the second set of dependency sequence constitute a second set, third-party libraries referenced by the various submodules in the third set of dependency sequence constitute a third set, and third-party libraries referenced by the various submodules in the fourth set of dependency sequence constitute a fourth set. In this case, the first set of dependency sequence may be paired with the third set of dependency sequence, the first set of dependency sequence may also be paired with the fourth set of dependency sequence, the second set of dependency sequence may be paired with the third set of dependency sequence, and the second set of dependency sequence may also be paired with the fourth set of dependency sequence. No other pairing relationships are established.

After the dependency sequence is determined, the set of third-party libraries may be determined according to the third-party libraries referenced by the various submodules in the dependency sequence. Table 1 provides an example of third-party libraries referenced by the first set of dependency sequence.

TABLE 1

| Dependency | | |
|---|---|---|
| Hierarchy | groupid | artifactid |
| 1 | org.elasticsearch | elasticsearch-secure-sm |
| 2 | org.elasticsearch | elasticsearch-x-content |
| 3 | org.elasticsearch | elasticsearch-lz4 |
| 4 | org.apache.lucene | lucene-core |
| 5 | org.apache.lucene | lucene-analyzers-common |
| 6 | org.apache.lucene | lucene-backward-codecs |
| 7 | jakarta.json | jakarta.json-api |

The names of third-party libraries usually follow a naming convention, and the naming convention includes at least two parts: groupid and artifactid. groupid is a unique identifier for the name of an organization, institution, or company. artifactid is a unique identifier for a project in a project group, typically an abstract expression of functionality. Usually, groupid and artifactid may be used to uniquely identify a third-party library. In addition, the third-party library may also be represented in conjunction with another field, such as a version field. Usually, resource management tools (such as Maven and Gradle) manage various third-party libraries based on the naming convention. In an embodiment of determining a naming convention by using groupid, artifactid, and version, there are no third-party libraries with the same groupid and artifactid but different versions, as management tools such as Maven can automatically detect such conflict to avoid such situation. Table 1 takes third-party libraries named with groupid and artifactid as examples. Table 2 provides an example of third-party libraries referenced by the third set of dependency sequence.

TABLE 2

| Dependency | | |
|---|---|---|
| Hierarchy | groupid | artifactid |
| 1 | com.fasterxml.jackson.dataformat | jackson-dataformat-smile |
| 2 | org.elasticsearch | elasticsearch-geo |
| 3 | org.elasticsearch | elasticsearch-x-content |
| 4 | org.elasticsearch | elasticsearch-lz4 |
| 5 | org.apache.lucene | lucene-core |
| 6 | org.apache.lucene | lucene-analyzers-common |
| 7 | org.apache.lucene | lucene-backward-codecs |
| 8 | org.apache.lucene | lucene-grouping |

In this embodiment, a resource management tool (such as Maven and Gradle) may be used to automatically detect third-party libraries referenced within the module. By using this pairing method, unnecessary module processing can be reduced. Since various submodules in a module have the same programming identifier, that is, they are programmed by the same development group, it is not easy for the various submodules to be redundant, and therefore, it is unnecessary to pair and process the various submodules under the same module. This can reduce the time complexity from O((n+m)²) to O(n×m), thus improving the processing efficiency, wherein n represents the number of the submodules of the first module, and m represents the number of the submodules of the second module.

Returning to the embodiment of FIG. 3, after the pairing, the process proceeds to 306 to determine the set of third-party libraries referenced by each module. Then, a degree of correlation is calculated at 308. The calculation of the degree of correlation includes determining an identifier matrix according to a union of the set of third-party libraries referenced by the module A and the set of third-party libraries referenced by the module B. For example, the set of third-party libraries referenced by the module A is {org.elasticsearch, org.apache.lucene}, the set of third-party libraries referenced by the module B is {com.aaabbb, org.apache.lucene}, and the union is {org.elasticsearch, org.apache.lucene, com.aaabbb}. Because the names of third-party libraries usually follow a naming convention, the naming convention includes at least two parts: groupid and artifactid. In other words, the name of a third-party library is usually uniquely identified by fields in a plurality of dimensions. Therefore, an identifier matrix may be created with a groupid value as the horizontal coordinate and an artifactid value as the vertical coordinate. For example, the first element (1, 1) of an identifier matrix M indicates whether the third-party library org.elasticsearch is referenced, wherein the first row of the identifier matrix M indicates that the groupid is org.elasticsearch, and the first column of the identifier matrix M indicates that the artifactid is elasticsearch-geo. The identifier matrix M may be initialized to zero.

The calculation of the degree of correlation further includes determining a first identifier matrix according to the set of third-party libraries referenced by the module A and the identifier matrix. For example, each third-party library in the set may be traversed, and the identifier matrix M may be identified according to the naming convention mentioned above to obtain an identifier matrix M1. For example, if the set of third-party libraries includes a certain third-party library, the element corresponding to the third-party library is set to a first numerical value (such as the number “1”) in the identifier matrix M1. Taking Table 1 as an example, the identifier matrix M1 may be (1, 1, 1, 0, 0, 0, 0, 0, 0, 0; 0, 0, 0, 1, 1, 1, 0, 0, 0, 0; 0, 0, 0, 0, 0, 0, 1, 0, 0, 0; 0, 0, 0, 0, 0, 0, 0, 0, 0, 0).

The calculation of the degree of correlation further includes determining a second identifier matrix according to the set of third-party libraries referenced by the module B and the identifier matrix. For example, each third-party library in the set may be traversed, and the identifier matrix M may be identified according to the naming convention mentioned above to obtain an identifier matrix M2. For example, if the set of third-party libraries includes a certain third-party library, the element corresponding to the third-party library is set to a second numerical value (such as the number “1”) in the identifier matrix M2. Taking Table 2 as an example, the identifier matrix M2 may be (0, 1, 1, 0, 0, 0, 0, 0, 1, 0; 0, 0, 0, 1, 1, 1, 0, 0, 0, 1; 0, 0, 0, 0, 0, 0, 0, 0, 0, 0; 0, 0, 0, 0, 0, 0, 0, 1, 0, 0). When the code for the identifier matrix is generated, a function that determines a dependency sequence of the modules may be defined first. The function reads the dependency sequence of the modules from a specified location, such as an XML file, according to an input path. Then, a function that generates an identifier matrix is defined, wherein the function reads the set of third-party libraries referenced by the modules and identifiers of the various third-party libraries by calling the function that determines the dependency sequence of the modules, while recording the groupid and artifactid of each third-party library. Furthermore, the two sets of third-party libraries are merged through a union operation to determine the scale of the identifier matrix, thereby generating a mapping table (that is, the identifier matrix). Finally, values are assigned to the corresponding elements of various identifier matrices according to the sets of third-party libraries of various modules. For each referenced third-party library, a value of 1 is assigned to the corresponding element of the identifier matrix, and a value of 0 is assigned to the corresponding element of an unreferenced third-party library.

The calculating the degree of correlation further includes determining the degree of correlation according to the identifier matrix M1 and the identifier matrix M2. In this embodiment, a solution is provided for quantifying the sets of third-party libraries referenced by the module A and the module B, and by performing operations on the identifier matrices M1 and M2, the degree of correlation between the module A and the module B can be quickly and accurately calculated.

When the degree of correlation is calculated according to the identifier matrices, in some embodiments, the first identifier matrix and the second identifier matrix are compressed into a first compressed identifier vector with one dimension and a second compressed identifier vector with one dimension, respectively. For example, an identifier matrix may be decomposed into a plurality of one-dimensional vectors, and these one-dimensional vectors may be connected to obtain a compressed identifier vector. Dimension reduction may also be achieved through other vector flattening operations.

This embodiment further includes determining a first standard deviation and a second standard deviation of the first compressed identifier vector and the second compressed identifier vector, respectively, as well as determining a first deviation of each element in the first compressed identifier vector relative to a first mean value, and determining a second deviation of each element in the second compressed identifier vector relative to a second mean value. The standard deviation reflects the distribution of values of various elements in the identifier matrix, while the deviation reflects the degree of correlation between the values of various elements in the identifier matrix. This embodiment further includes determining the degree of correlation according to each first deviation, each second deviation, the first standard deviation, and the second standard deviation. This embodiment considers the degree of correlation and the distribution of values of elements between different identifier matrices, which not only takes into account the number of identical third-party libraries, but also takes into account the proportion of identical third-party libraries to all third-party libraries in the identifier matrix and other factors. Therefore, the degree of correlation between different identifier matrices can be accurately determined. For example, the degree of correlation between the identifier matrices M1 and M2 may be calculated according to a formula (1).

$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}} \qquad Formula ( 1 )$$

wherein r is the degree of correlation, i is a positive integer, n is the number of elements in the identifier matrix M1 or M2 (the two matrices have the same number of elements), xᵢ is the i-th element in M1, x is the mean value of the elements in M1, yᵢ is the i-th element in M2, and Y is the mean value of the elements in M1. When the degree of correlation is calculated according to the formula (1), the number of all elements, the sum of x×y, the sum of x, the sum of y, the sum of x×x, and the sum of y×y may be calculated first. Then, the various quantities are substituted into the formula (1) to calculate the degree of correlation.

Due to the possibility of similarity between different third-party libraries, the identifier matrix may be optimized. In some embodiments, a functional tag subset 1 corresponding to a third-party library a is determined according to a preset functional tag set. The functional tags in the functional tag set indicate various functional features, such as a network detection function. In addition, a functional tag subset corresponding to each third-party library in the set of third-party libraries referenced by the module B is determined according to the preset functional tag set, and a functional tag subset having the largest intersection with the functional tag subset 1 is selected from the functional tag subsets corresponding to all the third-party libraries in the set of third-party libraries referenced by the module B to serve as a functional tag subset 2. Then, a first numerical value is determined according to the intersection of the functional tag subset 2 and the functional tag subset 1. A second numerical value may be determined in a similar manner. In addition, when further calculating the degree of correlation between modules based on the optimization of the identifier matrix in this embodiment, the method of calculating the degree of correlation described in the previous embodiment may be adopted to calculate the degree of correlation.

FIG. 4B is a schematic diagram of determining an identifier matrix according to an embodiment of the present disclosure. For simplicity, some modules and submodules in FIG. 4B refer to the content in FIG. 4A. A module 418 includes submodules 424, 422, and 420. In this embodiment, a set of third-party libraries referenced by a dependency sequence with the submodule 424 as a root node represents the set of third-party libraries referenced by the submodule 424. A functional tag subset corresponding to the third-party libraries referenced by the submodule 416 is {F1, F2, F3}, and a functional tag subset corresponding to the third-party libraries referenced by the submodule 424 is {F2, F4}. Moreover, the set of third-party libraries referenced by the submodule 424 represents the set of third-party libraries of the module 418 and does not include other third-party libraries. Therefore, the third-party libraries referenced by the module 424 is the third-party libraries having the largest intersection with the functional tag subset {F1, F2, F3}. Then, it may be determined that the degree of correlation between the two third-party libraries is ⅓×½=⅙, wherein ⅓ represents F2/(F1+F2+F3), and ½ represents F2/(F2+F4).

Taking M1 and M2 as examples, assuming that the degree of correlation between the third-party library (located in the 4th row and 8th column of M1) with the groupid being jakarta.json and the artifactid being jakarta.json-api and the third-party library (located in the 3rd row and 7th column of M2) with the groupid being com.fasterxml.jackson.dataformat and the artifactid being jackson-dataformat-smile is ⅙. Then, M1 may be redefined as M3: (1, 1, 1, 0, 0, 0, 0, 0, 0, 0; 0, 0, 0, 1, 1, 1, 0, 0, 0, 0; 0, 0, 0, 0, 0, 0, 1, 0, 0, 0; 0, 0, 0, 0, 0, 0, 0, ⅙, 0, 0), and M2 may be redefined as M4: (0, 1, 1, 0, 0, 0, 0, 0, 1, 0; 0, 0, 0, 1, 1, 1, 0, 0, 0, 1; 0, 0, 0, 0, 0, 0, ⅙, 0, 0, 0; 0, 0, 0, 0, 0, 0, 0, 1, 0, 0). This embodiment considers the degree of correlation between different third-party libraries and provides a more accurate solution for determining the identifier matrix, which is beneficial for improving the accuracy of calculating the degree of correlation between sets of third-party libraries, thereby improving the accuracy of calculating the degree of correlation between modules.

FIG. 4C is a contrastive diagram of the degree of correlation according to an embodiment of the present disclosure. A dashed line 432 represents the change in the degree of correlation between the identifier matrices M1 and M2 before optimizing the identifier matrix, wherein the circle represents the third-party library referenced by the module A and the triangle represents the third-party library referenced by the module B. In the optimization process, the small triangle in 434 indicates the existence of a third-party library in the module B that has a certain degree of correlation with the third-party library represented by the circle (for example, from the functional perspective), while the small circle in 436 indicates the existence of a third-party library in the module A that has a certain degree of correlation with the third-party library represented by the triangle (for example, from the functional perspective). A solid line 430 represents the change in the degree of correlation between the identifier matrices M1 and M2 after optimizing the identifier matrix. As can be seen therefrom, as the slope increases, the degree of correlation between M3 and M4 also increases. According to the formula (1), the degree of correlation between M1 and M2 is calculated to be 0.592156, and the degree of correlation between M3 and M4 increases to 0.640305, which is consistent with FIG. 4C.

Returning to the embodiment of FIG. 3, after calculating the degree of correlation 308, the process proceeds to 310 to determine whether module replacement is necessary. In the embodiment of calculating the degree of correlation according to the formula (1), a predetermined threshold may be determined according to Table 3.

TABLE 3

| Calculation Result | Degree of Correlation |
|---|---|
| Greater than 0.5 | Strong |
| 0.3-0.5 | Medium |
| 0-0.3 | Weak |
| 0 | None |
| Less than 0 | None |

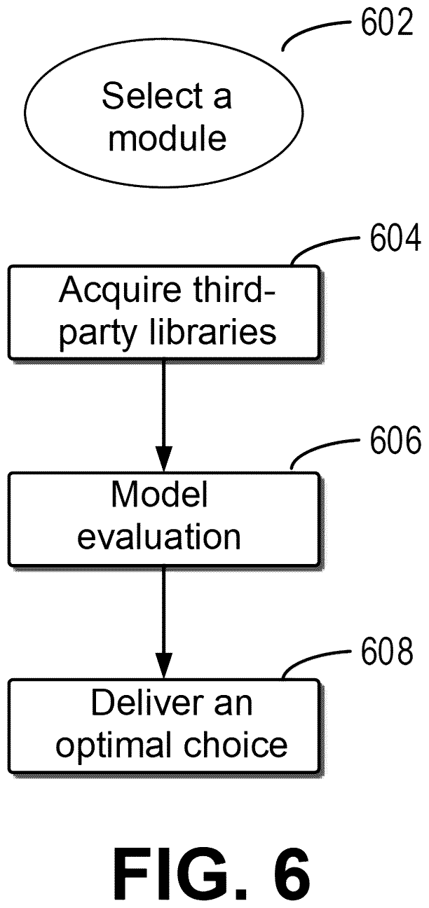

For different situations, the threshold may be set with reference to Table 3. The degree of correlation between M1 and M2 may be calculated as 0.592156 using the formula (1), and therefore, there is a strong correlation between M1 and M2, and at least one of the module A and the module B may be adjusted. Then, the process proceeds to 312 to use a model to evaluate the module A and the module B for determining which module needs to be adjusted. For this, reference can be made to FIG. 6. FIG. 6 is a schematic diagram of module adjustment according to an embodiment of the present disclosure. The process of selecting a module to be processed starts at 602. At 604, various third-party libraries (such as al to an) in the set of third-party libraries referenced by the module A and various third-party libraries (such as bl to bn) in the set of third-party libraries referenced by the module B are acquired. At 606, a model is used for evaluating the third-party libraries in each set of third-party libraries, that is, evaluating the third-party libraries al to an and evaluating the third-party libraries bl to bn, so as to score the module A and the module B. At 608, the module with the highest score is delivered as the optimal choice.

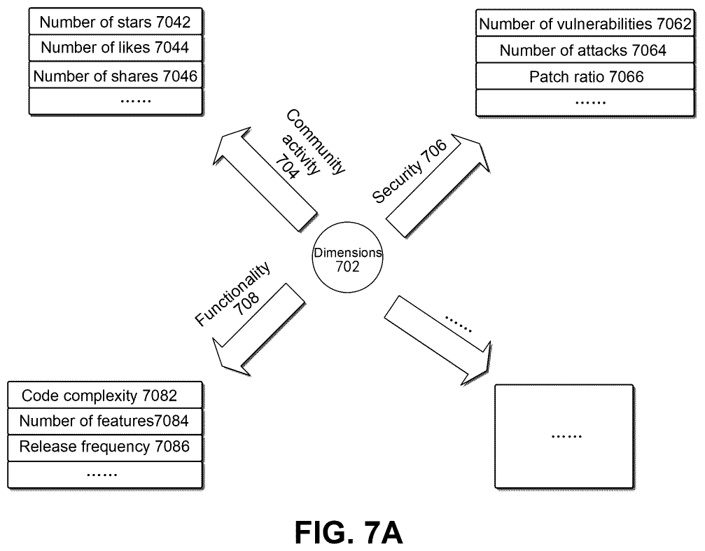

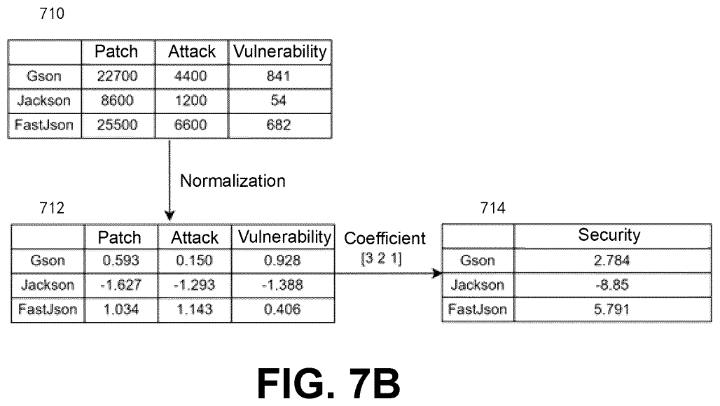

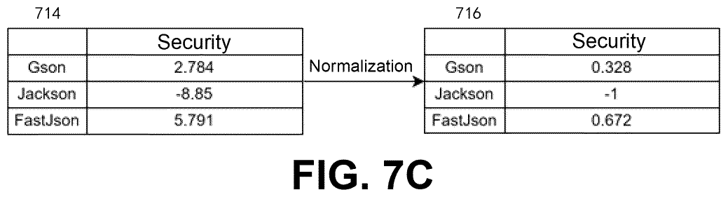

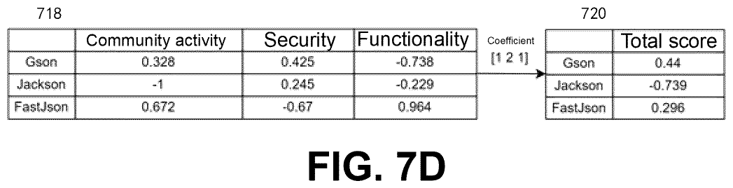

In some embodiments, a first score of each third-party library in the set of third-party libraries referenced by the module A and a second score of each third-party library in the set of third-party libraries referenced by the module B are determined respectively according to a plurality of attributes in a plurality of dimensions. FIG. 7A is a schematic diagram of module evaluation according to an embodiment of the present disclosure. In the embodiment shown in FIG. 7A, a module A is used as an example for evaluation.

As shown in FIG. 7A, a plurality of evaluation dimensions 702, including community activity 704, security 706, and functionality 708, may be preset to evaluate each third-party library. In the community activity 704, the third-party library may be evaluated in terms of number of stars 7042, number of likes 7044, number of shares 7046, and the like. In the security 706, the third-party library may be evaluated in terms of number of vulnerabilities 7062, number of attacks 7064, patch ratio 7066, and the like. In the functionality 708, the third-party library may be evaluated in terms of code complexity 7082, number of features 7084, release frequency 7086, and the like.

This embodiment further includes determining a first total score according to each first score, determining a second total score according to each second score, and determining the module to be adjusted according to the comparison between the first total score and the second total score and adjusting the module. Taking two dimensions as an example, the implementation of calculating the first score may include normalizing data of each third-party library in a plurality of attributes in a first dimension to obtain a first initial score vector, and dot-multiplying the first initial score vector by a first coefficient vector to obtain a first initial score. FIG. 7B is a schematic diagram of calculating an initial score according to an embodiment of the present disclosure. 710 shows data of three third-party libraries Gson, Jackson, and FastJson on three attributes in the security, that is, the number of modifications, the number of attacks, and the number of vulnerabilities. After normalization, the data in 712 is obtained. At this time, the size of each attribute can be referenced. Negative numbers are the result of normalization, aimed at eliminating dimensional differences between different attributes. The data in 712 is multiplied by a coefficient [3 2 1] to obtain 714, that is, the first initial score of each third-party library. For example, the normalization operation may be implemented by referring to a formula (2).

$${Z}_{a} = \frac{{q}_{j} - \overline{q}}{\sqrt{\frac{{\sum }_{j = 1}^{m} {( {q}_{j} - \overline{q} )}^{2}}{m}}} \qquad Formula ( 2 )$$

wherein Zₐ is the result of the normalization operation, j is a positive integer, qⱼ is the jth piece of data that needs to be normalized, q̅ is the mean value of all pieces of data that need to be normalized, and m is the quantity of pieces of data that need to be normalized (that is, all values of a certain attribute in a certain dimension). For this, a dot-multiplication operation may be implemented according to a formula (3).

$${D}_{1} = [ {z}_{a} {z}_{b} {z}_{c} … ] \times [ \begin{matrix}α \\ β \\ γ \\ …\end{matrix} ] \qquad Formula ( 3 )$$

wherein D₁ is the dot-multiplication result, [zₐ z_{b} z_{c} . . . ] is the initial score vector, wherein elements are different values of attributes, and

$$\begin{matrix}α \\ β \\ γ \\ …\end{matrix}$$

is the coefficient vector, wherein elements are specific coefficients.

The calculation of initial scores in other dimensions is similar, that is, data of the third-party library in a plurality of attributes of a second dimension is normalized to obtain a second initial score vector, and the second initial score vector is dot-multiplied by a second coefficient vector to obtain a second initial score.

The implementation of calculating the first score further includes normalizing the first initial score and the second initial score to obtain a first intermediate score vector. FIG. 7C is a schematic diagram of calculating an intermediate score vector according to an embodiment of the present disclosure. 714 only shows a score situation of one dimension (security), and after normalization together with other dimensions, the score situation of security is shown in 716. The implementation of calculating the first score further includes dot-multiplying the first intermediate score vector by a third coefficient vector to obtain the first score. When the second score is calculated for other modules, it may be performed with reference to the method of calculating the first score. FIG. 7D is a schematic diagram of calculating a score according to an embodiment of the present disclosure. 718 shows the result of normalization of security together with data of other dimensions. The data in 718 is multiplied by a coefficient [1 2 1] to obtain 720, that is, a total score of various third-party libraries (that is, the first score). When a total score of the module A (that is, a first total score) is calculated, the total scores of the third-party libraries included in it may be directly accumulated according to 720, and the accumulated result may be used as the total score of the module A. The method of calculating a total score of the module B (that is, a second total score) is similar to this.

Returning to the example in FIG. 3, assuming that the first total score of the module A is 1 point and the second total score of the module B is 2 points, and the module B is superior to the module A while being similar to the module A. A replacement suggestion may be proposed to replace the module A with the module B for the development group to choose, and the process proceeds to 314 to save the calculation result. In this way, when it is necessary to compare the module A with the module B again, whether the comparison result of the module A with the module B is saved locally may be first checked. If the result exists, there is no need to perform comparison again, but the comparison result is directly retrieved. Finally, at 316, with the approval of the development group, the module B is delivered to the development group (such as 102 in FIG. 1) to replace the module A. Alternatively, in the case where the target application is stored locally, the module A may be directly deleted, and the module B may undertake the corresponding functions of the original module A. In other embodiments, the module A with a low total score is merged with the module B with a high total score to obtain a merged module. Then, the merged module is used to replace the module A, so that the unique function of the module A can be retained, which is beneficial to eliminating redundancy and reducing the impact on the quality of the target application.

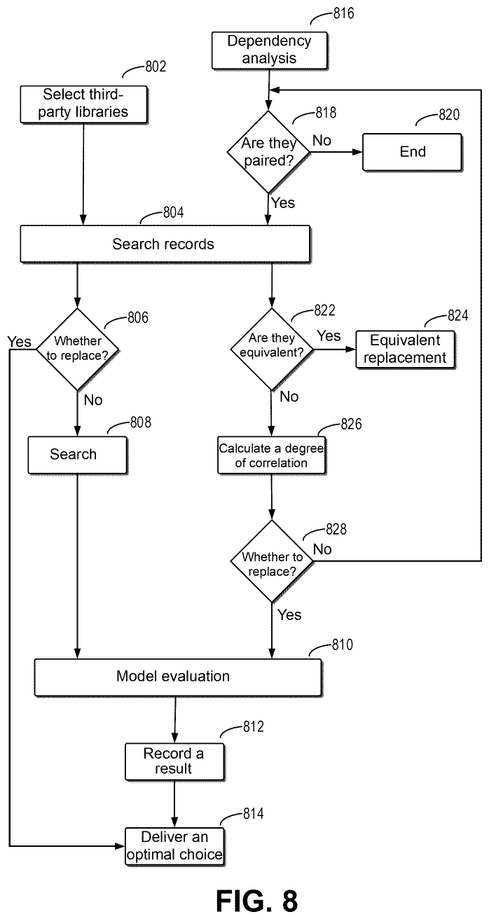

FIG. 8 is a schematic diagram of a method for processing modules according to an embodiment of the present disclosure. In this embodiment, a module may be programmed by a development group while the module processing unit 110 provides a module processing suggestion or performs corresponding processing.

The development group is assigned, for example, a task of programming a module C (such as a module in a new project). The development group selects, at 802, third-party libraries that need to be referenced, and then searches records at 804 to see if these third-party libraries have ever been used for replacement or merging. If yes (for example, it is recorded that the module C was replaced with the module B), the process proceeds to 806 to determine if replacement is needed. If the development group chooses yes, the development group does not need to perform programming but directly replaces the module C with the module B. If the development group chooses no, the development group may search for the most suitable module for replacement (such as a module D) at 808. Then, the process proceeds to 810 to evaluate various third-party libraries of the module C and the module D by using a model, and records the evaluation results at 812. At 814, the module C is replaced with the optimal module D according to the evaluation results.

In this embodiment, the records may be updated in real time. After starting analyzing dependencies between modules at 816, the process proceeds to 818 to determine if the two analyzed modules (such as the module A and the module B) are paired. If they are not paired, this analysis ends at 820. If paired, the process proceeds to 804 to search records to see if equivalent analysis has already been performed. At 822, it is determined whether the found record is equivalent to the currently ongoing analysis (that is, whether the referenced sets of third-party libraries are essentially the same). If they are equivalent, equivalent replacement is performed at 824, such as replacing a module equivalent to the module A with a module equivalent to the module B, so as to eliminate redundancy. If they are not equivalent, the process proceeds to 826 to calculate the degree of correlation between the two modules according to the previous embodiment, and then the process proceeds to 828 to determine whether the two modules need to be replaced. If no replacement is needed, the process proceeds to 818 to select a new submodule (a submodule with empty depended parameters) as a root node to re-determine whether the two modules are paired. If it is determined at 828 that replacement is needed, the process proceeds to 810 to determine which module is better, and at 812, the evaluation result is recorded in a database for querying, thereby improving the utilization of the calculated degree of correlation. At 814, the optimal module is used to replace another module according to the evaluation result.

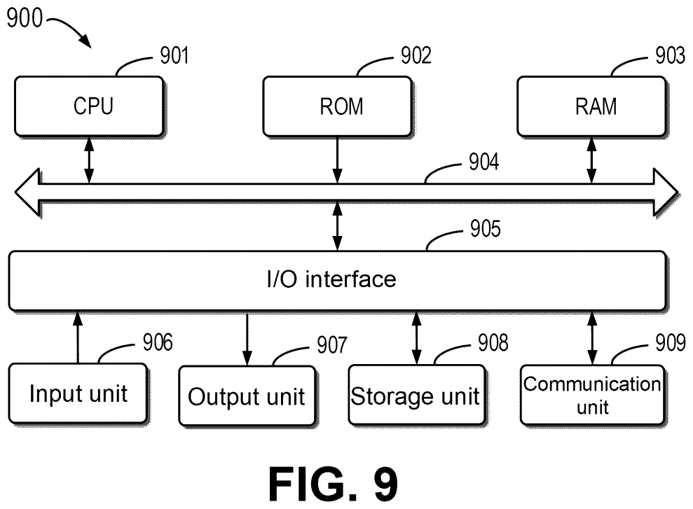

FIG. 9 illustrates a schematic block diagram of an example device 900 which can be used to implement embodiments of the present disclosure. As illustrated in the figure, the device 900 includes a computing unit 901 that can execute various appropriate actions and processing according to computer program instructions stored in a read-only memory (ROM) 902 or computer program instructions loaded from a storage unit 908 to a random access memory (RAM) 903. Various programs and data required for the operation of the device 900 may also be stored in the RAM 903. The computing unit 901, the ROM 902, and the RAM 903 are connected to each other through a bus 904. An input/output (I/O) interface 905 is also connected to the bus 904.

A plurality of components in the device 900 are connected to the I/O interface 905 and include: an input unit 906, such as a keyboard and a mouse; an output unit 907, such as various types of displays and speakers; the storage unit 908, such as a magnetic disk and an optical disc; and a communication unit 909, such as a network card, a modem, and a wireless communication transceiver. The communication unit 909 allows the device 900 to exchange information/data with other devices via a computer network, such as the Internet, and/or various telecommunication networks.

The computing unit 901 may be various general-purpose and/or special-purpose processing components with processing and computing capabilities. Some examples of computing units 901 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 901 performs various methods and processes described above, such as the method 200. For example, in some embodiments, the method 200 may be implemented as a computer software program that is tangibly included in a machine-readable medium, such as the storage unit 908. In some embodiments, part or all of the computer program may be loaded and/or installed onto the device 900 via the ROM 902 and/or the communication unit 909. When the computer program is loaded to the RAM 903 and executed by the computing unit 901, one or more steps of the method 200 described above may be performed. Alternatively, in other embodiments, the computing unit 901 may be configured to implement the method 200 in any other suitable manners (such as by means of firmware).

The functions described herein above may be executed at least in part by one or more hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Load Programmable Logic Device (CPLD), and the like.

Program codes for implementing the methods of the present disclosure may be written by using one programming language or any combination of multiple programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, it should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, wherein the programming languages include object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of network, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, the apparatus (system), and the computer program product according to the embodiments of the present disclosure. It should be understood that each block of the flow charts and/or the block diagrams and combinations of blocks in the flow charts and/or the block diagrams may be implemented by the computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, produce means for implementing the functions/acts specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored thereon includes an article of manufacture that includes instructions that implement various aspects of the functions/actions specified in one or more blocks in the flow charts and/or block diagrams.

The computer-readable program instructions may also be loaded onto a computer, other programmable data processing apparatuses, or other devices, such that a series of operations or steps are performed on the computer, other programmable data processing apparatuses, or other devices to produce a computer-implemented process, such that the instructions executed on the computer, other programmable data processing apparatuses, or other devices implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed essentially in parallel, and sometimes they may also be executed in a reverse order, depending on the functions involved. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

The embodiments of the present disclosure have been described above. The above description is illustrative rather than exhaustive, and is not limited to the disclosed various embodiments. Numerous modifications and alterations are apparent to persons of ordinary skill in the art without departing from the scope and spirit of the illustrated embodiments. The selection of terms used herein is intended to best explain the principles and practical applications of the various embodiments or the improvements to technologies on the market, or to enable other persons of ordinary skill in the art to understand the embodiments disclosed here.

1. A method for processing modules, comprising:
determining a first set of third-party libraries referenced by a first module in a target application and a second set of third-party libraries referenced by a second module in the target application;
determining a degree of correlation between the first set of third-party libraries and the second set of third-party libraries; and
adjusting at least one of the first module and the second module in response to the degree of correlation being greater than a predetermined threshold.

2. The method according to claim 1, wherein the first module and the second module have different programming identifiers, and determining the first set of third-party libraries referenced by the first module in the target application and the second set of third-party libraries referenced by the second module in the target application comprises:
determining a first submodule in the first module and a second submodule in the second module, wherein the first submodule and the second submodule are not depended on by other submodules;
determining a first submodule set associated with the first submodule in the first module, and determining a second submodule set associated with the second submodule in the second module, wherein the first submodule is directly or indirectly dependent on a submodule in the first submodule set, and the second submodule is directly or indirectly dependent on a submodule in the second submodule set; and
determining third-party libraries referenced by the first submodule and the first submodule set as the first set of third-party libraries, and determining third-party libraries referenced by the second submodule and the second submodule set as the second set of third-party libraries.

3. The method according to claim 1, wherein determining the degree of correlation between the first set of third-party libraries and the second set of third-party libraries comprises:
determining an identifier matrix according to a union of the first set of third-party libraries and the second set of third-party libraries;
determining a first identifier matrix according to the first set of third-party libraries and the identifier matrix;
determining a second identifier matrix according to the second set of third-party libraries and the identifier matrix; and
determining the degree of correlation according to the first identifier matrix and the second identifier matrix.

4. The method according to claim 3, wherein the identifier matrix is a two-dimensional matrix, the identifier matrix is initialized to zero, and determining the first identifier matrix according to the first set of third-party libraries and the identifier matrix comprises:
setting, in response to the first set of third-party libraries comprising a first third-party library, an element corresponding to the first third-party library to a first numerical value in the first identifier matrix;
and determining the second identifier matrix according to the second set of third-party libraries and the identifier matrix comprises:
setting, in response to the second set of third-party libraries comprising a second third-party library, an element corresponding to the second third-party library to a second numerical value in the second identifier matrix.

5. The method according to claim 4, wherein setting the element corresponding to the first third-party library to the first numerical value in the first identifier matrix comprises:
determining a first functional tag subset corresponding to the first third-party library according to a preset functional tag set;
determining a functional tag subset corresponding to each third-party library in the second set of third-party libraries according to the preset functional tag set;
selecting a functional tag subset having the largest intersection with the first functional tag subset from the functional tag subsets corresponding to the third-party libraries in the second set of third-party libraries as a target functional tag subset; and
determining the first numerical value according to the intersection of the target functional tag subset and the first functional tag subset.

6. The method according to claim 4, wherein determining the degree of correlation according to the first identifier matrix and the second identifier matrix comprises:
compressing the first identifier matrix and the second identifier matrix into a first compressed identifier vector with one dimension and a second compressed identifier vector with one dimension, respectively;
determining a first standard deviation and a second standard deviation of the first compressed identifier vector and the second compressed identifier vector, respectively;
determining a first deviation of each element in the first compressed identifier vector relative to a first mean value, and determining a second deviation of each element in the second compressed identifier vector relative to a second mean value; and
determining the degree of correlation according to each first deviation, each second deviation, the first standard deviation, and the second standard deviation.

7. The method according to claim 1, wherein adjusting at least one of the first module and the second module comprises:
determining a first score for each third-party library in the first set of third-party libraries and a second score for each third-party library in the second set of third-party libraries respectively according to a plurality of attributes of a plurality of dimensions;
determining a first total score according to each first score;
determining a second total score according to each second score; and
determining the module to be adjusted according to the comparison between the first total score and the second total score, and adjusting the module.

8. The method according to claim 7, wherein the plurality of dimensions comprise a first dimension and a second dimension, and determining the first score for each third-party library in the first set of third-party libraries respectively according to the plurality of attributes of the plurality of dimensions comprises:
normalizing data of each third-party library in a plurality of attributes of the first dimension to obtain a first initial score vector;
dot-multiplying the first initial score vector by a first coefficient vector to obtain a first initial score;
normalizing data of the third-party library in a plurality of attributes of the second dimension to obtain a second initial score vector;
dot-multiplying the second initial score vector by a second coefficient vector to obtain a second initial score;
normalizing the first initial score and the second initial score to obtain a first intermediate score vector; and
dot-multiplying the first intermediate score vector by a third coefficient vector to obtain the first score.

9. The method according to claim 8, wherein determining the module to be adjusted according to the comparison between the first total score and the second total score, and adjusting the module comprises:
determining, according to the first total score and the second total score, the module with a lower total score in the first module and the second module as a replaced module, and determining the module with a higher total score as a replacing module; and
replacing the replaced module by using the replacing module.

10. The method according to claim 8, wherein determining the module to be adjusted according to the comparison between the first total score and the second total score, and adjusting the module comprises:
determining, according to the first total score and the second total score, the module with a lower total score in the first module and the second module as a target module;
merging the first module with the second module to obtain a merged module; and
replacing the target module with the merged module.

11. An electronic device, comprising:
at least one processor; and
a memory coupled to the at least one processor and having instructions stored thereon, wherein the instructions, when executed by the at least one processor, cause the electronic device to perform following operations:
determining a first set of third-party libraries referenced by a first module in a target application and a second set of third-party libraries referenced by a second module in the target application;
determining a degree of correlation between the first set of third-party libraries and the second set of third-party libraries; and
adjusting at least one of the first module and the second module in response to the degree of correlation being greater than a predetermined threshold.

12. The electronic device according to claim 11, wherein the first module and the second module have different programming identifiers, and determining the first set of third-party libraries referenced by the first module in the target application and the second set of third-party libraries referenced by the second module in the target application comprises:
determining a first submodule in the first module and a second submodule in the second module, wherein the first submodule and the second submodule are not depended on by other submodules;
determining a first submodule set associated with the first submodule in the first module, and determining a second submodule set associated with the second submodule in the second module, wherein the first submodule is directly or indirectly dependent on a submodule in the first submodule set, and the second submodule is directly or indirectly dependent on a submodule in the second submodule set; and
determining third-party libraries referenced by the first submodule and the first submodule set as the first set of third-party libraries, and determining third-party libraries referenced by the second submodule and the second submodule set as the second set of third-party libraries.

13. The electronic device according to claim 11, wherein determining the degree of correlation between the first set of third-party libraries and the second set of third-party libraries comprises:
determining an identifier matrix according to a union of the first set of third-party libraries and the second set of third-party libraries;
determining a first identifier matrix according to the first set of third-party libraries and the identifier matrix;
determining a second identifier matrix according to the second set of third-party libraries and the identifier matrix; and
determining the degree of correlation according to the first identifier matrix and the second identifier matrix.

14. The electronic device according to claim 13, wherein the identifier matrix is a two-dimensional matrix, the identifier matrix is initialized to zero, and determining the first identifier matrix according to the first set of third-party libraries and the identifier matrix comprises:
setting, in response to the first set of third-party libraries comprising a first third-party library, an element corresponding to the first third-party library to a first numerical value in the first identifier matrix;
and determining the second identifier matrix according to the second set of third-party libraries and the identifier matrix comprises:
setting, in response to the second set of third-party libraries comprising a second third-party library, an element corresponding to the second third-party library to a second numerical value in the second identifier matrix.

15. The electronic device according to claim 14, wherein setting the element corresponding to the first third-party library to the first numerical value in the first identifier matrix comprises:
determining a first functional tag subset corresponding to the first third-party library according to a preset functional tag set;
determining a functional tag subset corresponding to each third-party library in the second set of third-party libraries according to the preset functional tag set;
selecting a functional tag subset having the largest intersection with the first functional tag subset from the functional tag subsets corresponding to the third-party libraries in the second set of third-party libraries as a target functional tag subset; and
determining the first numerical value according to the intersection of the target functional tag subset and the first functional tag subset.

16. The electronic device according to claim 14, wherein determining the degree of correlation according to the first identifier matrix and the second identifier matrix comprises:
compressing the first identifier matrix and the second identifier matrix into a first compressed identifier vector with one dimension and a second compressed identifier vector with one dimension, respectively;
determining a first standard deviation and a second standard deviation of the first compressed identifier vector and the second compressed identifier vector, respectively;
determining a first deviation of each element in the first compressed identifier vector relative to a first mean value, and determining a second deviation of each element in the second compressed identifier vector relative to a second mean value; and
determining the degree of correlation according to each first deviation, each second deviation, the first standard deviation, and the second standard deviation.

17. The electronic device according to claim 11, wherein adjusting at least one of the first module and the second module comprises:
determining a first score for each third-party library in the first set of third-party libraries and a second score for each third-party library in the second set of third-party libraries respectively according to a plurality of attributes of a plurality of dimensions;
determining a first total score according to each first score;
determining a second total score according to each second score; and
determining the module to be adjusted according to the comparison between the first total score and the second total score, and adjusting the module.

18. The electronic device according to claim 17, wherein the plurality of dimensions comprise a first dimension and a second dimension, and determining the first score for each third-party library in the first set of third-party libraries respectively according to the plurality of attributes of the plurality of dimensions comprises:
normalizing data of each third-party library in a plurality of attributes of the first dimension to obtain a first initial score vector;
dot-multiplying the first initial score vector by a first coefficient vector to obtain a first initial score;
normalizing data of the third-party library in a plurality of attributes of the second dimension to obtain a second initial score vector;
dot-multiplying the second initial score vector by a second coefficient vector to obtain a second initial score;
normalizing the first initial score and the second initial score to obtain a first intermediate score vector; and
dot-multiplying the first intermediate score vector by a third coefficient vector to obtain the first score.

19. The electronic device according to claim 18, wherein determining the module to be adjusted according to the comparison between the first total score and the second total score, and adjusting the module comprises:
determining, according to the first total score and the second total score, the module with a lower total score in the first module and the second module as a replaced module, and determining the module with a higher total score as a replacing module; and
replacing the replaced module by using the replacing module.

20. A non-transitory computer-readable medium comprising machine-executable instructions, which when executed by a machine, cause the machine to perform following operations:
determining a first set of third-party libraries referenced by a first module in a target application and a second set of third-party libraries referenced by a second module in the target application;
determining a degree of correlation between the first set of third-party libraries and the second set of third-party libraries; and
adjusting at least one of the first module and the second module in response to the degree of correlation being greater than a predetermined threshold.
